(19) United States
(12) Patent Application Publication
(10) Pub. No.: US 2014/0241017 A1
(43) Pub. Date: Aug. 28, 2014

(54) INPUT CIRCUIT AND POWER SUPPLY CIRCUIT

(71) Applicant: Kabushiki Kaisha Toshiba, Tokyo (JP)

(72) Inventor: Kei Kasai, Kanagawa (JP)

(21) Appl. No.: 13/937,748

(22) Filed: Jul. 9, 2013

(30) Foreign Application Priority Data
Feb. 28, 2013 (JP) 2013-039878

(51) Int. Cl. H02M 1/32; H02M 1/36

(52) U.S. Cl. CPC H02M 1/32; H02M 1/36
USPC 363/49; 363/50

(57) ABSTRACT

An input circuit connected to a semiconductor circuit is configured to receive a voltage indicating an on/off operation state of a power supply and to output a voltage that is lower than a breakdown voltage of the semiconductor circuit. The input circuit includes a first nMOS transistor and a resistor element. The first nMOS transistor has a drain receiving an outside voltage, a gate receiving a bias voltage higher than a power supply voltage inputted to a semiconductor circuit, and a source connected to the semiconductor circuit. The first nMOS transistor has a breakdown voltage higher than the power supply voltage inputted to the semiconductor circuit. One end of the resistor element connects with the source of the first nMOS transistor, while the other end connects with a reference potential of the semiconductor circuit.

### CROSS-REFERENCE TO RELATED APPLICATION

This application is based upon and claims the benefit of priority from Japanese Patent Application No. 2013-039878, filed on Feb. 28, 2013, the entire contents of which are incorporated herein by reference.

### FIELD

Embodiments described herein relate to an input circuit and a power supply circuit.

### BACKGROUND

A DC-DC converter is a type of power supply circuit that converts an input DC voltage at one level into an output DC voltage at a second level. A DC-DC converter often includes a semiconductor circuit. Generally, an allowable maximum voltage is determined as a breakdown voltage of the semiconductor circuit. When a semiconductor circuit receives a voltage higher than the breakdown voltage, the semiconductor circuit may be broken.

### DESCRIPTION OF THE DRAWINGS

FIG. 1 is a block diagram showing the general structure of a power supply circuit including an input circuit according to a first embodiment.

FIG. 2 is a graph depicting the relationship between an enable voltage and an enable output voltage.

FIG. 3 shows a simulated waveform depicting the relationship between the enable voltage and an enable current.

FIG. 4 is a circuit diagram showing a structure of an input circuit.

FIG. 5 is a circuit diagram showing an example of a bias voltage generating circuit in an input circuit according to a second embodiment.

FIG. 6 is a circuit diagram showing a structure of an input circuit according to a third embodiment.

FIG. 7 is a graph depicting the relationship between the enable voltage and a voltage Va.

FIG. 8 is a graph depicting the relationship between the voltage Va and an enable output voltage.

FIG. 9 shows a simulated waveform representing the relationship between the enable voltage and the enable current.

FIG. 10 is a circuit diagram showing a structure of an input circuit.

FIG. 11 shows a simulated waveform depicting the relationship between the enable voltage and the enable current.

FIG. 12 is a circuit diagram showing a structure of an input circuit.

FIG. 13 is a circuit diagram showing a structure of an input circuit.

FIG. 14 is a block diagram showing the general structure of a power supply circuit including an input circuit according to a fourth embodiment.

FIG. 15 is a block diagram showing the general structure of a power supply circuit including an input circuit according to a fifth embodiment.

FIG. 16 depicts a change of a soft-start voltage with time.

FIG. 17 is a block diagram showing the general structure of a power supply circuit.

### DETAILED DESCRIPTION

Embodiments provide an input circuit capable of limiting a voltage inputted to a semiconductor circuit and a power supply circuit including this input circuit. An embodiment of a power supply circuit includes an input circuit connected to a semiconductor circuit (e.g., an inverter circuit). The input circuit receives an enable voltage indicating an operation state (e.g., ON/OFF) of a power supply circuit, and outputs an enable output voltage that is lower than a breakdown voltage of the semiconductor circuit. The input circuit comprises a first nMOS transistor with a drain connected to an enable voltage input terminal receiving the enable voltage, a gate electrode for receiving a bias voltage that is higher than a power supply voltage, and a source electrode connected to the semiconductor circuit. The first nMOS transistor has a breakdown voltage that is higher than the power supply voltage. A resistor element is connected to the source electrode of the first nMOS transistor, and the first nMOS transistor operates in a non-saturation range when the enable voltage is lower than or equal to a predetermined value and in a saturation range when the enable voltage is higher than the predetermined value.

Specific embodiments are hereinafter described with reference to the drawings.

### First Embodiment

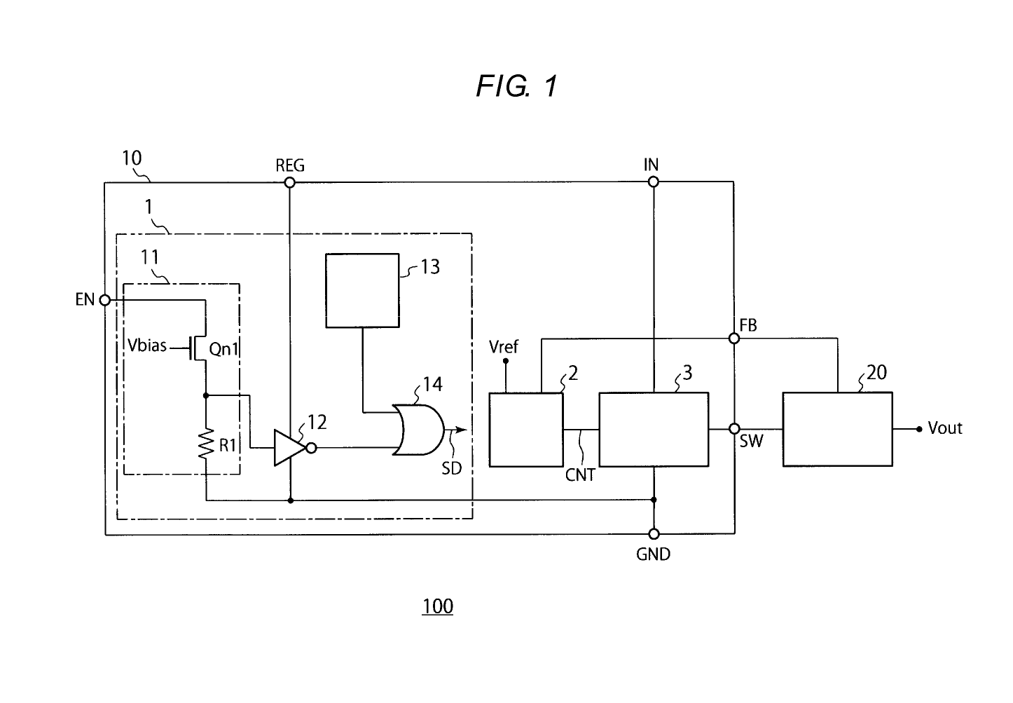

FIG. 1 is a block diagram showing the general structure of a power supply circuit 100 including an input circuit 11 according to a first embodiment. The power supply circuit 100 is a DC-DC converter which converts an input voltage Vin (5V, for example) of dc voltage into an output voltage Vout of dc voltage having a different voltage value, and supplies the converted voltage to a load (not shown).

The power supply circuit 100 includes a start control unit 1, a control circuit 2, a switching voltage generating unit 3, and an output voltage generating unit 20. This figure shows a configuration example of a power supply circuit in which the start control unit 1, the control circuit 2, and the switching voltage generating unit 3 are disposed on one semiconductor integrated circuit 10.

The semiconductor integrated circuit 10 includes an input terminal IN receiving the input voltage Vin, a power supply terminal REG receiving a power supply voltage Vreg (5V, for example), a ground terminal GND receiving a ground voltage Vgnd, an enable terminal EN receiving an enable voltage Ven, and a feedback terminal FB receiving a feedback voltage Vfb as input terminals. The semiconductor integrated circuit 10 further includes a switching terminal SW outputting a switching voltage Vsw as an output terminal.

The start control unit 1 provided within the semiconductor integrated circuit 10 generates a shutdown signal SD (first control signal) which determines whether or not to operate the power supply circuit 100 considering the enable voltage Ven for controlling the start of the power supply circuit 100. The shutdown signal SD can be supplied to various circuits within the semiconductor integrated circuit 10.

The control circuit 2 stops when the shutdown signal SD indicates that the power supply circuit 100 is not allowed to operate. When the shutdown signal SD indicates that the power supply circuit 100 is allowed to operate, the control circuit 2 generates a control signal CNT (second control signal) for producing the output voltage Vout close to a desired voltage based on the feedback voltage Vfb proportional to the output voltage Vout. More specifically, the control circuit 2 generates the control signal CNT in accordance with the difference between a predetermined reference voltage Vref and the feedback voltage Vfb.

The switching voltage generating unit 3 stops when the shutdown signal SD indicates that the power supply circuit 100 is not allowed to operate. When the shutdown signal SD indicates that the power supply circuit 100 is allowed to operate, the switching voltage generating unit 3 outputs the switching voltage Vsw in accordance with the control signal CNT. More specifically, the switching voltage generating unit 3 outputs the input voltage Vin or the ground voltage Vgnd as the switching voltage Vsw so as to decrease the difference between the reference voltage Vref and the feedback voltage Vfb.

The output voltage generating unit 20 provided outside the semiconductor integrated circuit 10 produces the output voltage Vout of dc voltage from the switching voltage Vsw corresponding to the output from the switching voltage generating unit 3. The output voltage generating unit 20 further generates the feedback voltage Vfb proportional to the output voltage Vout. The feedback voltage Vfb enters the feedback terminal FB of the semiconductor integrated circuit 10.

One of the characteristics of this embodiment is that the input circuit 11 is provided within the start control unit 1. The details of the start control unit 1 are now explained.

The start control unit 1 includes the input circuit 11, an inverter circuit 12, a protection circuit 13, and an OR circuit 14. The inverter circuit 12 and the OR circuit 14 are logical circuits formed of semiconductor circuits.

The input circuit 11 lies between the enable terminal EN receiving the enable voltage Ven from the outside and the inverter circuit 12 as a semiconductor circuit. For example, a user of the power supply circuit 100 in this embodiment sets the enable voltage Ven to HIGH for operation of the power supply circuit 100. On the other hand, the user sets the enable voltage Ven to LOW for stop of the power supply circuit 100. The input circuit 11 generates an enable output voltage Ven_out having the same logic as that of the enable voltage Ven.

The enable terminal EN receives the enable voltage Ven from a microcomputer, for example. In this case, the HIGH enable voltage Ven is 5V, for example, which is substantially equal to the power supply voltage Vreg. The enable terminal EN can also receive the enable voltage Ven directly from a high voltage power supply. In this case, the HIGH enable voltage Ven is 20V, for example, which is considerably higher than the power supply voltage Vreg.

The input circuit 11 generates the enable output voltage Ven_out such that Ven_out is limited to a voltage lower than the breakdown voltage of the inverter circuit 12 even when the enable voltage Ven is high. A specific example of the circuit structure of the input circuit 11 will be described below.

The inverter circuit 12 inverts the logic of the enable output voltage Ven_out. While the power supply voltage inputted to the inverter circuit 12 is Vreg, the logic threshold of the inverter circuit 12 is about Vreg/2. The inverter circuit 12 is constituted by a semiconductor circuit. According to this embodiment, it is assumed that the inverter circuit 12 is a complementary metal oxide semiconductor (CMOS) inverter circuit which has a p-type metal oxide semiconductor (pMOS) transistor and an n-type metal oxide semiconductor (nMOS) transistor connected by cascade connection between the power supply terminal REG and the ground terminal GND. The breakdown voltage of the inverter circuit 12 is substantially equivalent to the power supply voltage Vreg.

The protection circuit 13 includes a low-voltage protection circuit and a thermal shutdown circuit. The low-voltage protection circuit sets the output signal of the protection circuit 13 to HIGH when detecting that the output voltage Vout becomes a predetermined value or lower. On the other hand, the thermal shutdown circuit sets the output signal of the protection circuit 13 to HIGH when detecting that the temperature of the semiconductor integrated circuit 10 exceeds a predetermined value.

The OR circuit 14 calculates the logical sum of the output signals from the inverter circuit 12 and the protection circuit 13, and generates a shutdown signal SD. More specifically, when at least either the inverter circuit 12 or the protection circuit 13 outputs HIGH, the OR circuit 14 sets the shutdown signal to HIGH. The shutdown signal SD enters the respective units within the semiconductor integrated circuit 10. When the shutdown signal SD is HIGH, the respective units within the semiconductor integrated circuit 10 stop operations.

The circuit structure of the input circuit 11 is now explained. The input circuit 11 has an nMOS transistor Qn1 and a resistor element R1.

The transistor Qn1 has a drain connecting with the enable terminal EN, agate receiving a bias voltage Vbias, and a source connecting with the input terminal of the inverter circuit 12. Thus, the source voltage of the transistor Qn1 enters the inverter circuit 12 as the enable output voltage Ven_out.

The bias voltage Vbias may be either supplied from the outside to a bias terminal of the semiconductor integrated circuit 10 after the bias terminal is formed, or generated within the semiconductor integrated circuit 10. The bias voltage Vbias, which is higher than the power supply voltage Vreg inputted to the inverter circuit 12, is set to 5.7V, for example. This setting of the bias voltage Vbias limits the voltage of the enable output voltage Ven_out to a predetermined voltage or lower and also prevent flow of flow-through current in the inverter circuit 12.

The transistor Qn1 is a transistor having a high breakdown voltage such as a double diffusion MOS (DMOS). More specifically, the breakdown voltage of the transistor Qn1 is higher than the power supply voltage Vreg of the inverter circuit 12. The transistor Qn1 having a high breakdown voltage is used because the bias voltage Vbias applied to the gate is higher than the power supply voltage Vreg.

One end of the resistor element R1 connects with the source of the transistor Qn1. The other end of the resistor element R1 receives the ground voltage Vgnd (reference potential). The resistor element R1 is a pull-down resistor for fixing the enable output voltage Ven_out. The resistance R1 of the resistor element R1 is 500 kΩ, for example.

The operation of the input circuit 11 for limiting the value of the enable output voltage Ven_out is now explained with the assumption of the following conditions: the power supply voltage Vreg of 5V; the bias voltage Vbias of 5.7V; the threshold voltage Vthn for the transistor Qn1 of 0.7V; and the resistance R1 of 500 kΩ.

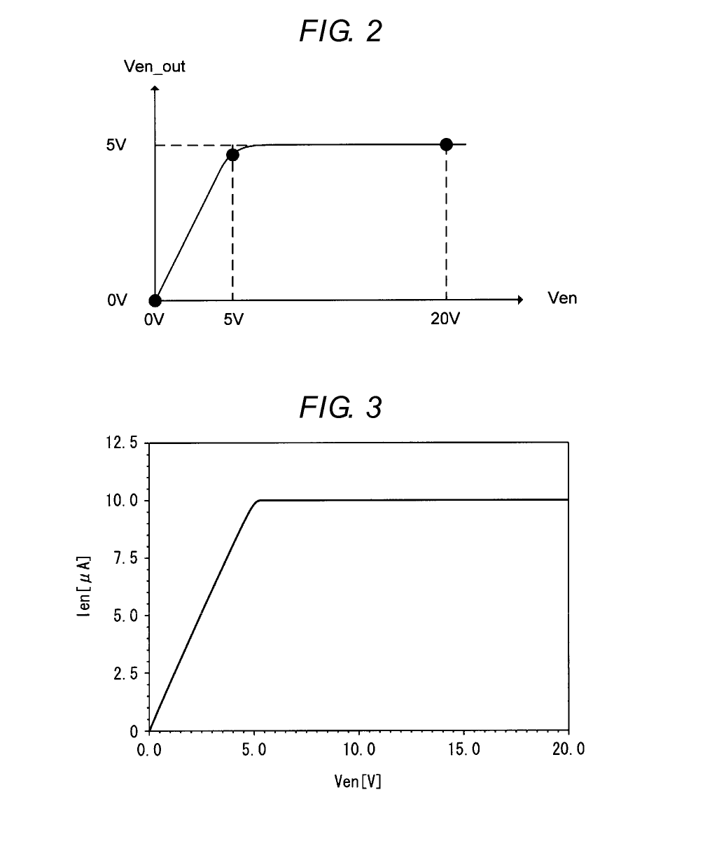

FIG. 2 is a graph depicting the relationship between the enable voltage Ven inputted to the input circuit 11 and the enable output voltage Ven_out outputted from the input circuit 11. As can be seen from the figure, the input circuit 11 sets the enable output voltage Ven_out to LOW (0V) when the enable voltage Ven is LOW (0V). On the other hand, the input circuit 11 sets the enable output voltage Ven_out to HIGH (5V) when the enable voltage Ven is HIGH (5V or 20V). This point is now described more specifically.

When the enable voltage Ven is lower than a predetermined value, more specifically, when the enable voltage Ven is lower than Vbias−Vthn (=5V), the transistor Qn1 operates in the non-saturation range (ON-resistor range). Thus, the source voltage of the transistor Qn1 (that is, voltage of enable output voltage Ven_out) is substantially equivalent to the enable voltage Ven. Accordingly, the transistor Qn1 has substantially no effect.

On the other hand, when the voltage Ven is higher than the predetermined voltage, more specifically, when the enable voltage Ven is approximately equivalent to Vbias−Vthn (=5V) or higher, the transistor Qn1 operates in the saturation range. Thus, the voltage of the enable output voltage Ven_out is limited to Vbias−Vthn (=5V).

By this method, the input circuit 11 limits the enable output voltage Ven_out to Vbias−Vthn even when the enable voltage Ven is high. By setting the bias voltage Vbias to an appropriate value considering the threshold voltage Vthn of the transistor Qn1, the enable output voltage Ven_out can be limited to a desired voltage.

The inverter circuit 12 shown in FIG. 1 inverts the enable output voltage Ven_out while setting the logic threshold to about 2.5V, and supplies the inverted enable output voltage Ven_out to the OR circuit 14.

Summarizing the above explanation, the enable output voltage Ven_out outputted from the input circuit 11 becomes 0V when the enable output voltage Ven is set to LOW (0V). Thus, the inverter circuit 12 outputs HIGH. As a result, the shutdown signal SD outputted from the OR circuit 14 becomes HIGH, whereby the power supply circuit 100 stops.

On the other hand, when the enable output voltage Ven is set to HIGH (5V or 20V), the enable output voltage Ven_out outputted from the input circuit 11 becomes 5V. In this case, the inverter circuit 12 outputs LOW. As a result, the shutdown signal SD outputted from the OR circuit 14 becomes LOW, whereby the power supply circuit 100 operates (assuming the signal from protection 13 is also LOW).

A method equalizing the bias voltage Vbias with the power supply voltage Vreg is conceivable. In this case, the enable output voltage Ven_out is limited to Vbias−Vthn (=Vreg−Vthn=4.3V). The voltage Vbias−Vthn is higher than the threshold voltage of the nMOS transistor within the inverter circuit 12. Thus, the nMOS transistor is turned on. The difference between the voltage Vbias−Vthn and the power supply voltage Vreg is 0.7V which is equal to or higher than the threshold voltage (about 0.7V) of the pMOS transistor within the inverter circuit 12. Thus, the pMOS transistor is also turned on. Thus, not only the nMOS transistor within the inverter circuit 12 but also the pMOS transistor therein is turned on. As a consequence, steady flow-through current flows in the inverter circuit 12 causing the current consumption in the input circuit 11 to increase.

However, this embodiment uses the bias voltage Vbias higher than the power supply voltage Vreg. In this case, the enable output voltage Ven_out is limited to Vbias−Vthn (>Vreg−Vthn). Accordingly, the pMOS transistor within the inverter circuit 12 maintains OFF condition, which prevents flow of flow-through current in the inverter circuit 12.

As discussed above, the bias voltage Vbias is determined such that current flowing in the inverter circuit 12 becomes a predetermined value or lower (preferably, no flow-through current flows), that is, the pMOS transistor within the inverter circuit 12 is turned off when the inverter circuit 12 receives the voltage calculated by subtracting the threshold voltage Vthn of the transistor Qn1 from the bias voltage Vbias.

It is preferable that the following relation (1) holds for securely turning off the pMOS transistor within the inverter circuit 12.

Vbias−Vthn>Vreg−Vthp (1)

The voltage Vthp included in the above relation corresponds to the threshold voltage of the pMOS transistor in the inverter circuit 12. When the voltages Vthn and Vthp are substantially equal to each other, the above relation (1) is expressed as the following relation (2), wherein the bias voltage Vbias is only required to be higher than the power supply voltage Vreg.

Vbias>Vreg (2)

FIG. 3 is a graph showing a simulated waveform representing the relationship between the enable voltage Ven and an enable current Ien flowing from the enable terminal EN to the input circuit 11.

When the enable voltage Ven is 5V or lower, the voltage Ven_out is approximately equal to the voltage yen as noted above. In this case, the enable current Ien=Ven_out/R1 becomes approximately equal to Ven/R1, wherefore the enable current Ien becomes substantially proportional to the enable voltage Ven.

On the other hand, when the enable voltage Ven is 5V or higher, the voltage Ven_out becomes equal to Vbias−Vthn as noted above. In this case, the enable output voltage Ven_out is constant regardless of the bias voltage Ven. Thus, the enable current Ien becomes equal to (Vbias−Vthn)/R1(=10.0 μA). Accordingly, the enable current Ien does not considerably increase even when the enable voltage Ven becomes higher, wherefore the enable current Ien can be limited to a substantially constant value.

According to the first embodiment, therefore, the inverter circuit 12 receives the enable voltage Ven via the transistor Qn1 having a high breakdown voltage. Moreover, the gate of the transistor Qn1 receives the bias voltage Vbias higher than the power supply voltage Vreg. This structure can limit the voltage of the enable output voltage Ven_out inputted to the inverter circuit 12, and prevent flow of flow-through current in the inverter circuit 12.

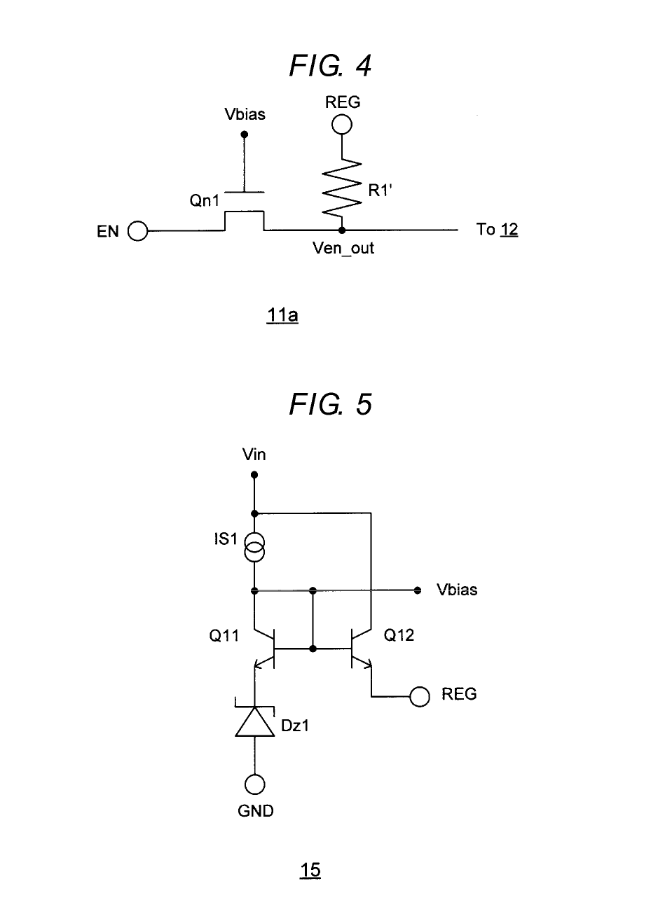

The input circuit 11 in FIG. 1 is shown only as an example, and can be modified in various forms. A modification example is an input circuit 11a shown in FIG. 4 which includes a pull-up resistor element R1′ in place of the pull-down resistance R1 shown in FIG. 2. One end of the resistor element R1′ connects with the source of the transistor Qn1, while the other end receives the power supply voltage Vreg (reference potential). Alternatively, the structure shown in FIG. 1 may include a Schmitt inverter circuit having hysteresis characteristics instead of the inverter circuit 12 to stabilize the enable output voltage Ven_out.

### Second Embodiment

According to a second embodiment described hereinafter, the start control unit 1 includes a bias voltage generating circuit. This bias voltage generating circuit produces the bias voltage Vbias from the power supply voltage Vreg.

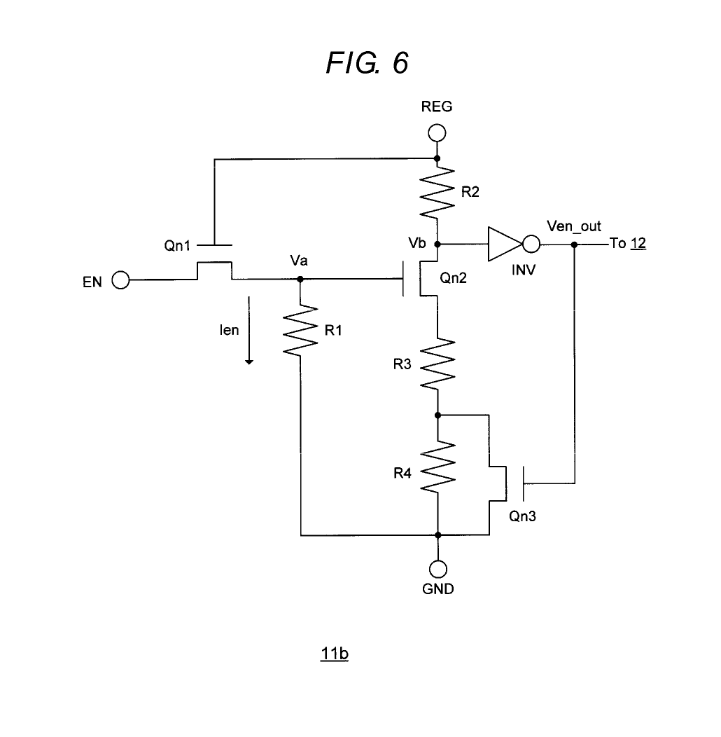

FIG. 5 is a circuit diagram showing an example of a bias voltage generating circuit 15 included in an input circuit according to the second embodiment. The bias voltage generating circuit 15 lies within the start control unit 1 shown in FIG. 1. The bias voltage generating circuit 15 has a current source IS1 connecting by cascade connection between the input terminal IN receiving the input voltage Vin and the ground terminal GND, an npn bipolar transistor Q11, a zener diode Dz1, and an npn bipolar transistor Q12 connecting between the terminal IN and the power supply terminal REG. The voltages of the collector and base of the transistor Q11 and the base of the transistor Q12 enter the input circuit 11 shown in FIG. 2 as the bias voltage Vbias.

In the bias voltage generating circuit 15, the bias voltage Vbias as the base voltage of the transistor Q12 is higher than the power supply voltage Vreg by a voltage Vbe between the base and emitter of the transistor Q12, and satisfies the following equation (3).

Vbias=Vreg+Vbe (3)

In this equation, the voltage Vbe is approximately 0.7V. In this case, the bias voltage generating circuit 15 generates the bias voltage Vbias higher than the power supply voltage Vreg.

Accordingly, the bias voltage generating circuit 15 in the second embodiment can produce the bias voltage Vbias higher than the power supply voltage Vreg from the power supply voltage Vreg without the necessity for a complicated structure.

### Third Embodiment

A third embodiment described herein pertains to an input circuit using the input of the enable voltage Ven to a transistor-transistor-logic (TTL) level having a logic threshold of the enable voltage Ven of approximately 1.2V. The third embodiment also relates to an input circuit having hysteresis characteristics. In the following description, the difference between the third embodiment and the first embodiment is described and discussion of similarities may be omitted.

FIG. 6 is a circuit diagram showing an example of the internal structure of an input circuit 11b according to the third embodiment. The input circuit 11b lies between the enable terminal EN receiving the enable voltage Ven from the outside and the inverter circuit 12. The input circuit 11b shown in FIG. 6 includes transistors Qn1 through Qn3, resistor elements R1 through R4, and an inverter circuit INV.

The transistor Qn1 has a drain connecting with the enable terminal EN, a gate receiving the power supply voltage Vreg, and a source connecting with a gate of the transistor Qn2.

According to this embodiment, the source of the transistor Qn1 connects not with a logic circuit such as an inverter circuit, but with the gate of the transistor Qn2. In this case, only a current limited by the resistor elements R2 through R4 flows in the transistor Qn2. Thus, current flowing from the power supply terminal REG into the ground terminal GND via the resistor element R2, the transistor Qn2, and the resistor elements R3 and R4 is lower than flow-through current flowing in an ordinary logic circuit.

Accordingly, the voltage supplied to the gate of the transistor Qn1 need not be higher than the power supply voltage Vreg. Since the voltage entering the gate is the power supply voltage Vreg, the transistor Qn1 is not required to have a high breakdown voltage.

The resistor element R1 is a pull-down resistor element. One end of the resistor element R1 connects with the source of the transistor Qn1, while the other end receives the ground voltage Vgnd.

The resistor element R2, the transistor Qn2, the resistor element R3, and the resistor element R4 connect in this respective order between the power supply terminal REG and the ground terminal GND. The gate of the transistor Qn2 connects with a connection node Va between the source of the transistor Qn1 and the resistor element R1.

The transistor Qn3 connects with the resistor element R4 in parallel. The input terminal of the inverter circuit INV connects with a connection node Vb between the resistor element R2 and the transistor Qn2. The output terminal of the inverter circuit INV connects with the gate of the transistor Qn3. The voltage of the output terminal of the inverter circuit INV enters the inverter circuit 12 shown in FIG. 1 as the enable output voltage Ven_out.

The operation of the input circuit 11b, particularly the hysteresis characteristics thereof, is now explained.

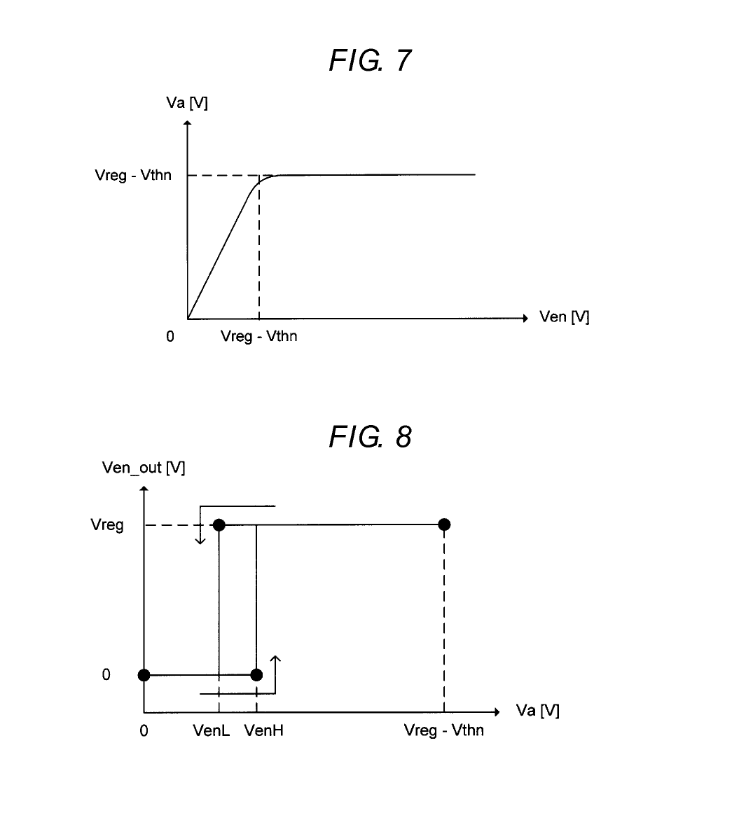

FIG. 7 is a graph depicting the relationship between the enable voltage Ven and the voltage Va. The relationship between these voltages Ven and Va is substantially equivalent to the relationship between the enable voltage Ven and the enable output voltage Ven_out shown in FIG. 2. However, the gate of the transistor Qn1 shown in FIG. 6 receives the power supply voltage Vreg. Thus, saturation occurs when the voltage Va becomes the value calculated by subtracting the threshold voltage Vthn of the transistor Qn1 from the power supply voltage Vreg.

As noted, saturation occurs when the voltage Va is Vreg−Vthn. In the following description, therefore, the range of the voltage Va from 0 to (Vreg−Vthn) is discussed. In this range, the voltage Ven is equal to the voltage Va.

FIG. 8 is a graph depicting the relationship between the voltage Va and the enable output voltage Vout_en. When the voltage Va is low, the transistor Qn2 shown in FIG. 6 is turned off. In this case, substantially no current flows in the resistor element R2, wherefore the voltage Vb is substantially equivalent to the power supply voltage Vreg. In this condition, the inverter circuit INV inverses the voltage Vb equivalent to the power supply voltage Vreg and outputs the LOW enable output voltage Ven_out. As a result, the transistor Qn3 is turned off.

When the voltage Va increases and exceeds the threshold of the transistor Qn2, the transistor Qn2 is turned on. In this case, current flowing from the power supply terminal REG into the ground terminal GND via the resistor element R2, the transistor Qn2, and the resistor elements R3 and R4 increases with the rise of the voltage Va. Accordingly, the voltage Vb decreases by the voltage drop at the resistor element R2.

When the voltage Vb becomes a logic threshold Vinv of the inverter circuit INV, the inverter circuit INV outputs the HIGH enable output voltage Ven_out (i.e., power supply voltage Vreg). In this case, the voltage Vb is equal to Vinv, and the source voltage of the transistor Qn2 is Va−Vth2=Ven−Vth2 (Vth2: threshold voltage of transistor Qn2). Moreover, current flowing in the resistor element R2 is equal to current flowing in the resistor elements R3 and R4. Based on these points, the following equation (3) holds.

(Vreg−Vinv)/R2=(Ven−Vth2)/(R3+R4) (3)

According to the above equation (3), an enable voltage VenH when the enable output voltage Ven_out outputted from the inverter circuit INV changes from LOW to HIGH by logical inversion is expressed by the following equation (4).

VenH=(Vreg−Vinv)*(R3+R4)/R2+Vth2 (4)

The resistor elements R2 through R4 are formed of appropriate resistor elements capable of producing the enable voltage VenH higher than the logic threshold at TTL level. Thereafter, the enable output voltage Ven_out outputted from the inverter circuit INV maintains HIGH even when the voltage Va increases up to Vreg−Vthn.

When the output from the inverter circuit INV is HIGH, the transistor Qn3 is turned on. In this condition, the resistor element R4 is considered to be short-circuited between the terminals.

When the voltage Va decreases in the next step, current flowing from the power supply terminal REG into the ground terminal GND via the resister element R2, the transistor Qn2, the resistor element R3 and the transistor Qn3 decreases. As a result, the voltage drop at the resistor element R2 decreases, wherefore the voltage Vb increases.

When the voltage Vb becomes the logical threshold Vinv of the transistor INV, the inverter circuit INV outputs the LOW enable output voltage Ven_out. In this case, the voltage Vb is equal to Vinv, and the source voltage of the transistor Qn2 is Va−Vth2=Ven−Vth2. Moreover, the resistor element R4 is considered to be short-circuited between the terminals, and the current flowing in the resistor element R2 is equivalent to current flowing in the resistor element R3. Based on these points, the following equation (5) holds.

(Vreg−Vinv)/R2=(Ven−Vth2)/R3 (5)

According to the above equation (5), an enable voltage VenL when the enable output voltage Ven_out outputted from the inverter circuit INV changes from HIGH to LOW by logical inversion is expressed by the following equation (6).

VenL=(Vreg−Vinv)*R3/R2+Vth2 (6)

The resistor elements R2 and R3 are formed of appropriate resistor elements capable of producing the enable voltage VenL lower than the logical threshold at TTL level. Thereafter, the enable output voltage Ven_out outputted from the inverter circuit INV maintains LOW even when the voltage Va decreases to 0V.

By this method, the input circuit 11b can produce the enable output voltage Ven_out having the same logic as that of the inputted enable voltage Ven and having hysteresis characteristics.

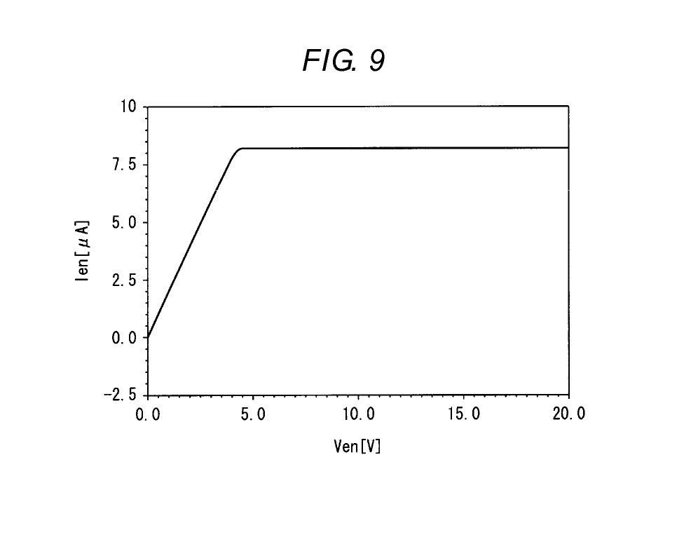

FIG. 9 shows a simulated waveform representing the relationship between the enable voltage Ven and the enable current Ien flowing from the enable terminal EN to the input circuit 11b. As can be seen from the figure, the enable current Ien is substantially proportional to the enable voltage Ven when the enable voltage Ven is Vreg−Vthn (=approximately 4.2V) or lower. The enable current Ien is limited to a substantially constant value even when the enable voltage exceeds Vreg−Vthn.

Accordingly, the third embodiment provides an input circuit 11b capable of receiving the enable voltage Ven at TTL level. Moreover, since the output from the inverter circuit INV enters the gate of the transistor Qn3, the input circuit 11b obtains hysteresis characteristics without using a Schmitt inverter circuit. Furthermore, the input circuit 11b which does not receive a voltage higher than the power supply voltage Vreg has a simplified structure.

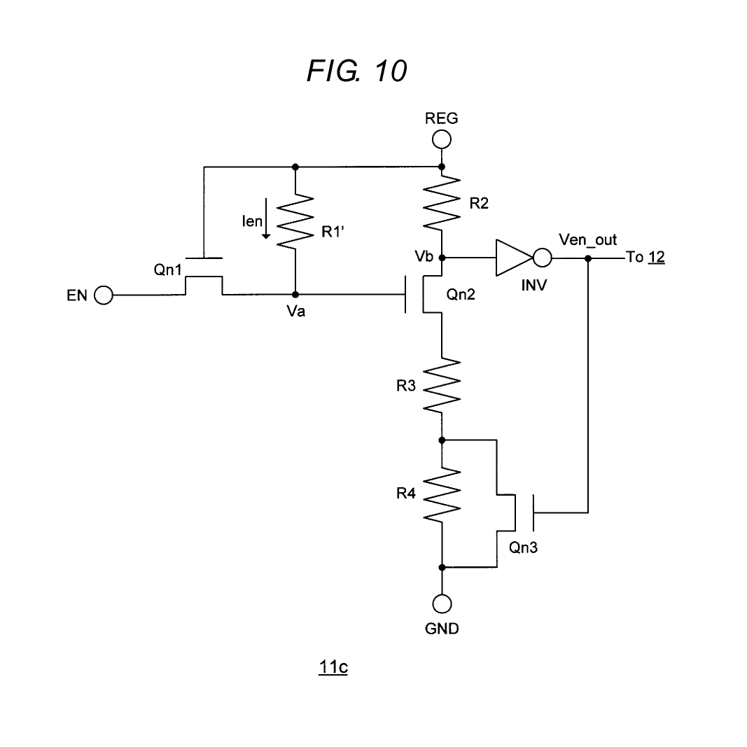

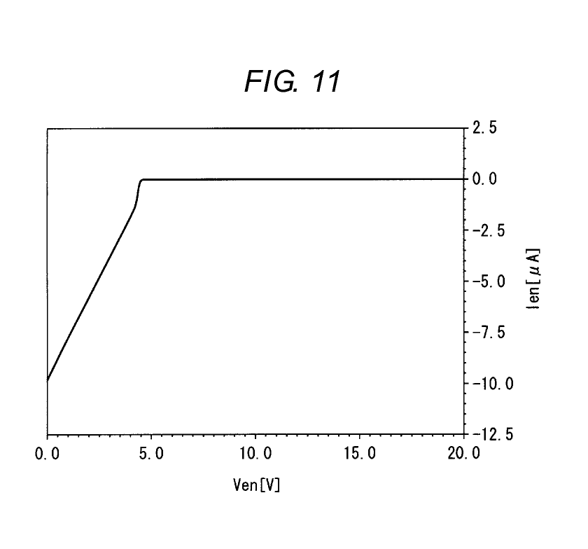

The input circuit 11b is shown only as an example, and may be modified in a variety of forms. A modification example is an input circuit 11c shown in FIG. 10 which includes the pull-up resistor element R1′ in place of the pull-down resistor element R1 shown in FIG. 6. One end of the resistor element R1′ connects with the source of the transistor Qn1, while the other end receives the power supply voltage Vreg. In this case, the enable voltage Ven and the enable current Ien has a relationship shown in FIG. 11.

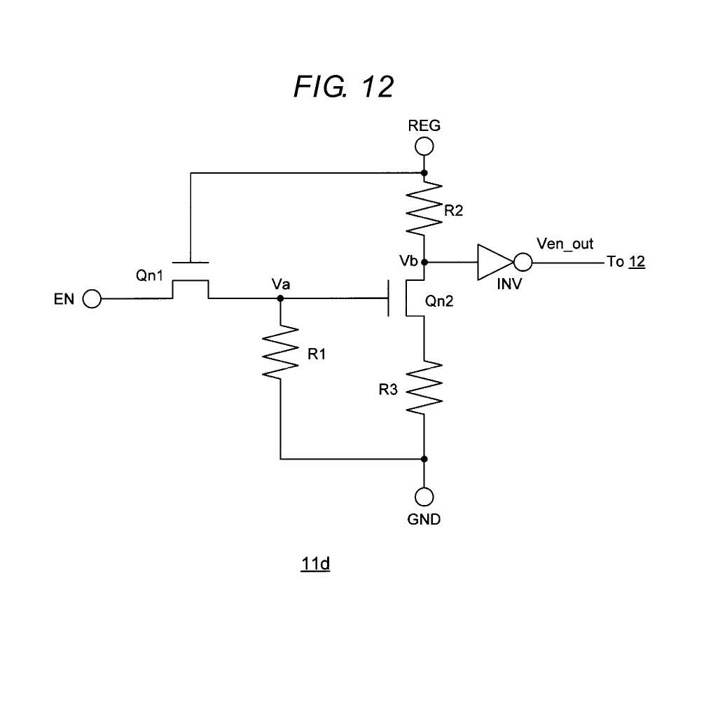

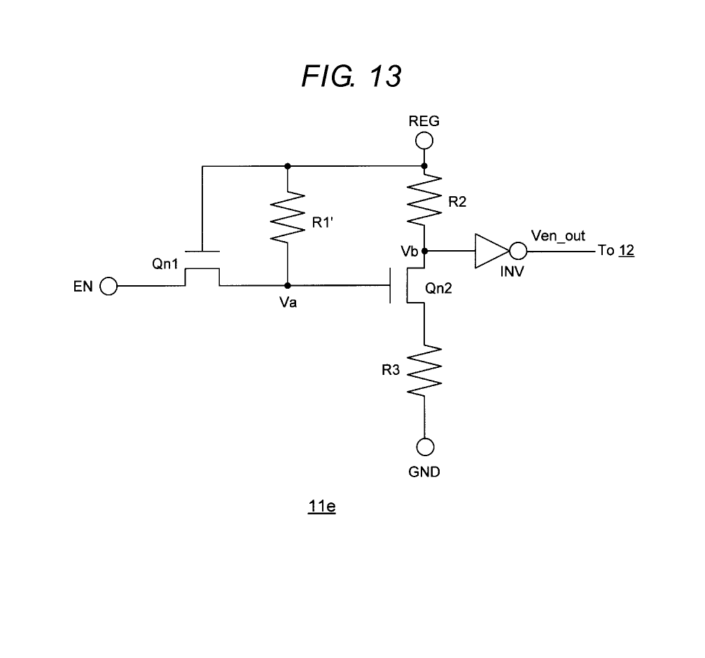

When the input circuit is not required to have hysteresis characteristics, the resistor element R4 and the transistor Qn3 may be eliminated as in examples of an input circuit 11d shown in FIG. 12 and an input circuit 11e shown in FIG. 13.

### Fourth Embodiment

While the input circuit lies within the start control unit 1 shown in FIG. 1 according to the first through third embodiments, an input circuit according to a fourth embodiment described herein lies within the control circuit 2.

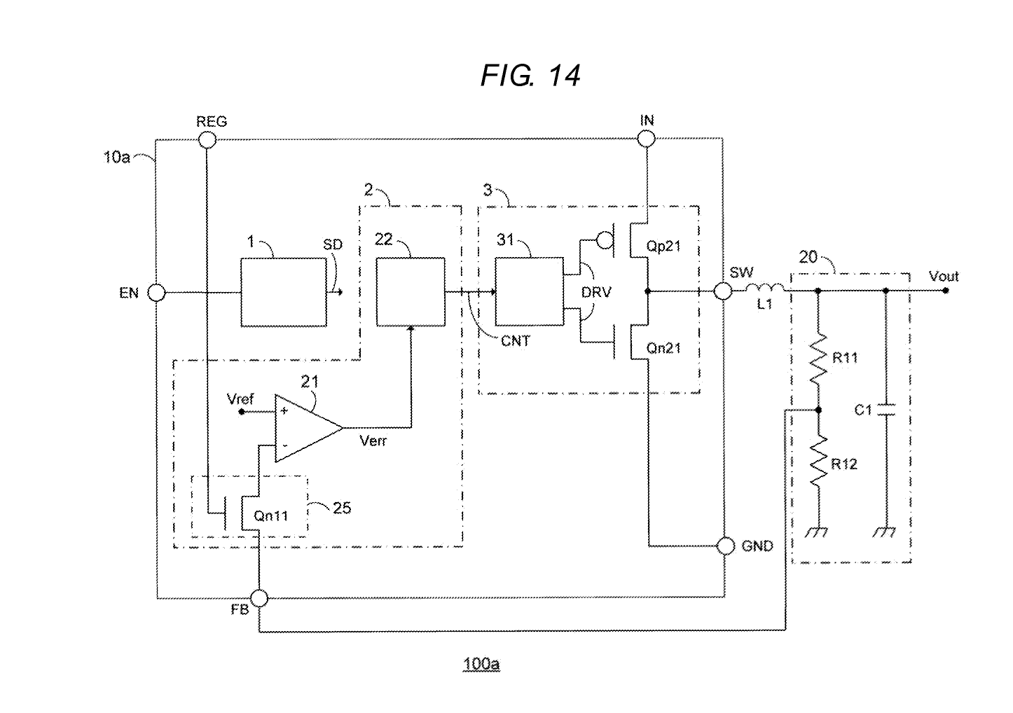

FIG. 14 is a block diagram showing the general structure of a power supply circuit 100a including an input circuit 25 according to the fourth embodiment. Initially, the structure of the power supply circuit 100a will be discussed.

The control circuit 2 includes an nMOS transistor Qn11 (second nMOS transistor) corresponding to the input circuit 25, an error amplifier 21, and a control unit 22. The transistor Qn11 has a drain receiving the feedback voltage Vfb corresponding to the output voltage Vout via the feedback terminal FB, a gate receiving the power supply voltage Vreg, and a source connecting with a negative input terminal of the error amplifier 21. A positive input terminal of the error amplifier 21 receives the predetermined reference voltage Vref. The error amplifier 21 generates an error voltage Verr representing the difference between the source voltage of the transistor Qn11 and the reference voltage Vref, and inputs the error voltage Verr to the control unit 22. The control unit 22 generates a control signal CNT in accordance with the error voltage Verr.

The switching voltage generating unit 3 includes a driver 31, a pMOS transistor Qp21, and an nMOS transistor Qn21. The driver 31 generates driving signals for the transistors Qp21 and Qn21 in accordance with the control signal CNT. The transistors Qp21 and Qn21 connect between the input terminal IN and the ground terminal GND. The connection node between the transistors Qp21 and Qn21 connects with the switching terminal SW.

The output voltage generating unit 20 disposed outside a semiconductor integrated circuit 10a has a coil L1, resistor elements R11 and R12, and a capacitor C1. The coil L1 connects between the switching terminal SW and an output terminal of the power supply circuit 100a outputting the output voltage Vout. The resistor elements R11 and R12 connect in series between the output terminal and the ground. The connection node between the resistor elements R11 and R12 connects with the feedback terminal FB. The capacitor C1 connects between the output terminal and the ground.

According to this embodiment, the transistor Qn11, the error amplifier 21, and the control unit 22 are on the semiconductor integrated circuit 10a, while the resistor elements R11 and R12 are outside the semiconductor integrated circuit 10a. The feedback voltage Vfb enters the drain of the transistor Qn11 from the outside of the semiconductor integrated circuit 10a via the feedback terminal FB of the semiconductor integrated circuit 10a.

The operation of the power supply circuit 100a is now explained.

The output voltage Vout is divided by the resistor elements R11 and R12. The voltage obtained by this division enters the feedback terminal FB as the feedback voltage Vfb. That is, the drain of the transistor Qn11 receives the feedback voltage Vfb corresponding to the output voltage Vout, more specifically, the feedback voltage Vfb proportional to the output voltage Vout.

The feedback voltage Vfb obtained by dividing the output voltage Vout using the resistor elements R11 and R12 is lower than the output voltage Vout. However, there is a case when the feedback terminal FB receives a high voltage. This case occurs when the feedback terminal FB and an output terminal OUT are short-circuited outside the semiconductor integrated circuit 10a, for example. When the output voltage Vout is higher than the power supply voltage Vreg, the feedback terminal FB receives a voltage higher than the power supply voltage Vreg. When such a high voltage enters the error amplifier 21, there is a possibility of breakdown of the error amplifier 21.

Therefore, this embodiment uses the transistor Qn11 disposed between the feedback terminal FB receiving the feedback voltage Vfb from the outside and the error amplifier 21 constituted by the semiconductor circuit. The transistor Qn11 is the input circuit 25 for the error amplifier 21, and Qn11 limits the input voltage to the error amplifier 21. In this specification, one element is referred to as a circuit in some cases—that is, “circuit” may refer to a single element in some instances.

The gate of the transistor Qn11 receives the power supply voltage Vreg. Thus, when the feedback voltage Vfb is lower than Vreg−Vth2 (Vth2: threshold voltage of transistor Qn11), the transistor Qn11 operates in the non-saturation range (ON-resistor range). In this case, the source voltage of the transistor Qn11 (i.e., input voltage to error amplifier 21) is substantially equivalent to the feedback voltage Vfb and the transistor Qn11 has substantially no effect.

On the other hand, when the feedback voltage Vfb is approximately equal to Vreg−Vth2 or higher, the transistor Qn11 operates in the saturation range. In this case, the input voltage to the error amplifier 21 is limited to Vreg−Vth2. That is, the input voltage to the error amplifier 21 is regulated to a voltage lower than the power supply voltage Vreg.

The error amplifier 21 generates the error voltage Verr corresponding to the difference between the reference voltage Vref and the source voltage of the transistor Qn11. The control unit 22 generates the control signal CNT based on the error voltage Verr.

The driver 31 within the switching voltage generating unit 3 generates a driving signal DRV in accordance with the control signal CNT. The driving signal DRV includes a driving signal for the transistor Qp21 and a driving signal for the transistor Qn21.

These driving signals are pulse width modulation (PWM) signals having a duty ratio in correspondence with the error voltage Verr, for example. The duty ratio in this context refers to the ratio of the cycle of the PMW signal to the HIGH period of the PWM signal. The driver 31 generates such a driving signal which produces the output voltage Vout close to a desired value, that is, the source voltage of the transistor Qn11 corresponding to the feedback voltage Vfb and having a value close to the reference voltage Vref.

More specifically, the PWM signal is generated so that the lower the source voltage of the transistor Qn11 (i.e., feedback voltage Vfb) than the reference voltage Vref becomes, the longer the ON period of the transistor Qp 21 becomes. On the other hand, the PWM signal is generated so that the higher the feedback voltage Vfb than the reference voltage Vref becomes, the longer the ON period of this transistor Qn 21 becomes.

The transistors Qp21 and Qn21 are turned on or off in accordance with the driving signal DRV. As a result, the switching terminal SW receives the switching voltage Vsw which switches between the input voltage Vin and the ground voltage Vgnd.

As noted above, the switching voltage generating unit 3 outputs the input voltage Vin or the ground voltage Vgnd in accordance with the control signal CNT so as to decrease the difference between the reference voltage Vref and the source voltage of the transistor Qn11.

The switching voltage Vsw enters one end of the coil L1. Assuming that the output terminal Vout is set as a reference, the voltage difference between the terminals of the inductor L1 is Vin−Vout when the transistor Qp21 is turned on, and is Vgnd−Vout when the transistor Qn21 is turned on. Thus, the coil L1 alternately receives positive and negative voltages, wherefore current having a triangle waveform flows in the coil L1.

When the current flowing in the coil L1 is balanced against the current flowing in the load (not shown) connected with the output terminal Vout, direct current flowing in the capacitor C1 is equivalent to zero. Thus, the output voltage Vout comes into a stable condition.

The feedback operation discussed above can produce the desired output voltage Vout.

Accordingly, the fourth embodiment provides the transistor Qn11 positioned between the feedback terminal FB and the error amplifier 21. This structure can eliminate the possibility of input of high voltage to the error amplifier 21.

### Fifth Embodiment

A fifth embodiment described herein relates to a power supply circuit having a soft-start function. The soft-start function in this context refers to a function which controls the output voltage Vout of the power supply circuit such that the output voltage Vout can gradually increase at the time of initial supply (e.g., startup) of the power supply voltage Vreg. This soft-start function can prevent excess current flow in the load connected to the power supply circuit that can be caused by a rapid start of operation of the power supply circuit.

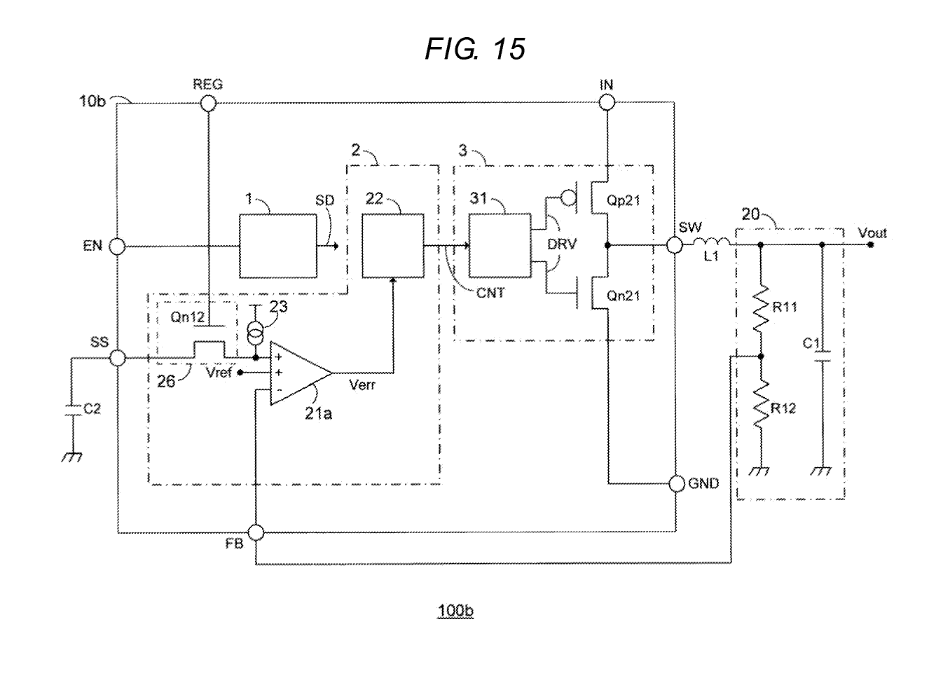

FIG. 15 is a block diagram showing the general structure of a power supply circuit 100b including an input circuit 26 according to the fifth embodiment. The different points in this embodiment from the structure shown in FIG. 14 are discussed herein.

For providing the soft-start function, the power supply circuit 100b includes a current source 23 and an nMOS transistor Qn12 (third nMOS transistor) corresponding to the input circuit 26, both of which are provided on a semiconductor integrated circuit 10b, and a capacitor C2 disposed outside the semiconductor integrated circuit 10b. The semiconductor integrated circuit 10b has a soft-start terminal SS as an input terminal.

The transistor Qn12 has a drain connected with the current source 23, a gate receiving the power supply voltage Vreg, and a source connected with one end of the capacitor C2 via the soft-start terminal SS. The other end of the capacitor C2 is grounded. The current source 23 supplies current to the capacitor C2 via the transistor Qn12.

An error amplifier 21a has first and second positive input terminals. The first positive input terminal of the error amplifier 21a receives the reference voltage Vref. The second positive input terminal of the error amplifier 21a connects with the connection node between the current source 23 and the transistor Qn12.

According to this embodiment, the transistor Qn12 lies between the soft-start terminal SS and the error amplifier 21a to constitute the input circuit 26 for the error amplifier 21a.

The operation of the power supply circuit 100b shown in FIG. 15 is now explained.

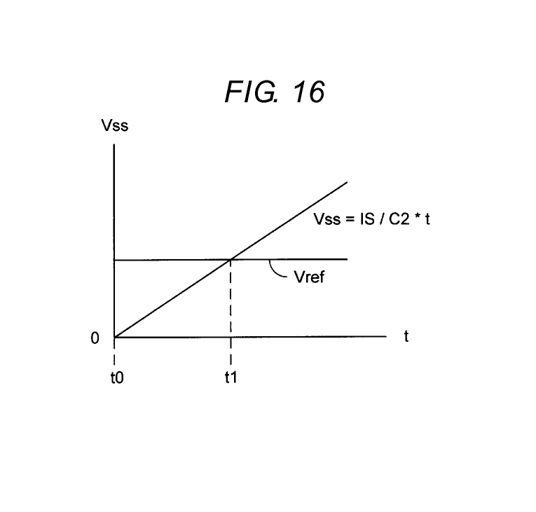

FIG. 16 schematically shows a change of a soft start voltage Vss with time. The soft-start voltage Vss in this context refers to a voltage of the soft-start terminal SS, and corresponds to the source voltage of the transistor Qn12. With supply of the power supply voltage Vreg at time t0, current flows from the current source 23 into the capacitor C2 via the transistor Qn12. This current causes accumulation of charges in the capacitor C2, whereby the soft-start voltage Vss increases as shown in FIG. 16. The inclination of this increase is expressed as IS/C2 (IS: current generated from the current source 23). Thus, the inclination decreases when the capacitor C2 to be used has a large capacity.

When the soft-start voltage Vss is lower than Vreg−Vth3 (Vth3: threshold voltage of transistor Qn12), the transistor Qn12 operates in the non-saturation range (ON resistor range). In this case, the drain voltage of the transistor Qn12 (i.e., input voltage to error amplifier 21a) is substantially equivalent to the soft-start voltage Vss corresponding to the source voltage of the transistor Qn12. Thus, the transistor Qn12 has substantially no effect.

On the other hand, when the drain voltage of the transistor Qn12 becomes around Vreg−Vth3 or higher, the transistor Qn12 operates in the saturation range. In this case, the input voltage to the error amplifier 21a is limited to Vreg−Vth3. That is, the input voltage to the error amplifier 21a is regulated to a voltage lower than the power supply voltage Vreg.

The error amplifier 21a generates the error voltage Verr in accordance with the difference between the feedback voltage Vfb proportional to the output voltage Vout and the lower one of the reference voltage Vref and the drain voltage of the transistor Qn12.

According to the example shown in FIG. 16, the error amplifier 21a generates the error voltage Verr in accordance with the soft-start voltage Vss and the feedback voltage Vfb up to time t1. After time t1, the error amplifier 21a generates the error voltage Verr in accordance with the difference between the reference voltage Vref and the feedback voltage Vfb. Accordingly, the output voltage Vout gradually increases after the supply of the power supply voltage Vreg.

Other points are substantially similar to the corresponding points in the fourth embodiment.

As noted above, the fifth embodiment provides the transistor Qn12 between the soft-start terminal SS and the error amplifier 21a. Thus, even when the soft-start terminal SS and the output terminal OUT are short-circuited, high voltage does not enter the error amplifier 21a.

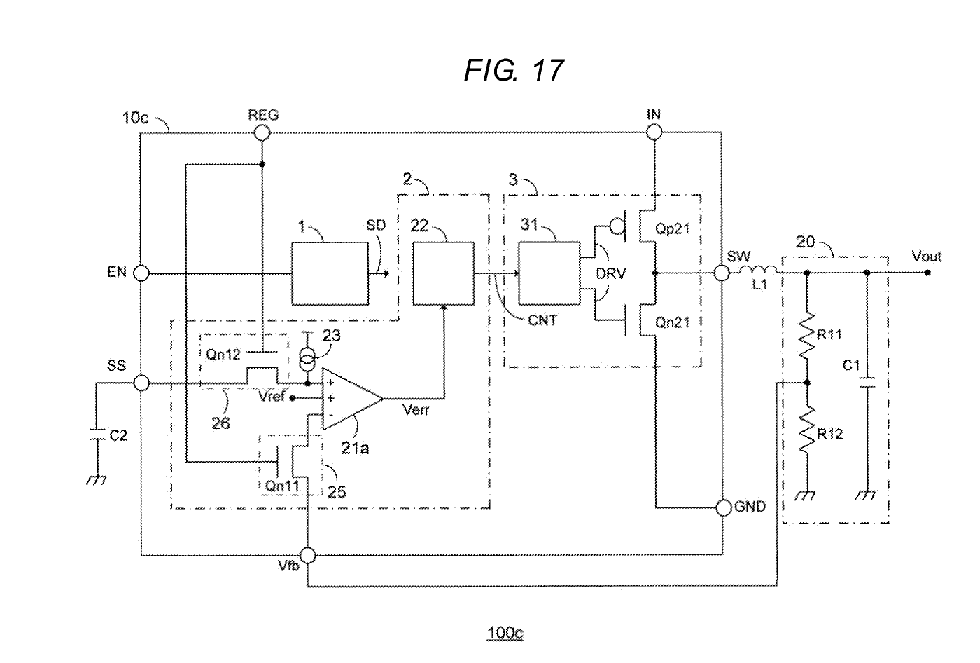

This embodiment may use a power supply circuit 100c shown in FIG. 17 which includes the transistor Qn12 as the input circuit 25 between the soft-start terminal SS and the error amplifier 21a, and the transistor Qn11 as the input circuit 26 between the feedback terminal FB and the error amplifier 21a.

The structures of the power supply circuits in FIG. 1 and other figures are shown only as examples. For example, the following modifications maybe made. The transistors Qp21 and Qn21 may lie outside the semiconductor integrated circuit. At least a part of the output voltage generating unit 20 may lie on the semiconductor integrated circuit.

At least a part of the MOS transistor may include other types of semiconductor elements such as a bipolar transistor. The power supply circuit may have a transistor of the opposite conductivity type, and the connection positions of the power supply terminal and the ground terminal may be oppositely disposed accordingly. In this case, the basic operational principle does not change.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power supply circuit, comprising:
an input circuit connected to a semiconductor circuit, the input circuit configured to receive an enable voltage indicating an operation state of a power supply circuit and to output an enable output voltage that is lower than a breakdown voltage of the semiconductor circuit, the input circuit including:
a first nMOS transistor having a drain electrode connected to an enable voltage input terminal for receiving the enable voltage, a gate electrode for receiving a bias voltage, the bias voltage being higher than a power supply voltage supplied to the semiconductor circuit, and a source electrode connected to the semiconductor circuit, the first nMOS transistor having a breakdown voltage higher than the power supply voltage; and
a resistor element connected to the source electrode of the first nMOS transistor, wherein
the first nMOS transistor operates in a non-saturation range when the enable voltage is lower than or equal to a predetermined value and in a saturation range when the enable voltage is higher than the predetermined value.

2. The power supply circuit according to claim 1, wherein
a flow-through current of the semiconductor circuit is a predetermined current value or lower when a voltage that is equal to the bias voltage minus a threshold voltage of the first nMOS transistor is applied to the semiconductor circuit.

3. The power supply circuit according to claim 1, wherein the semiconductor circuit is an inverter circuit.

4. The power supply circuit according to claim 3, wherein the inverter circuit includes a pMOS transistor that is turned off when a voltage that is equal to the bias voltage minus a threshold voltage of the first nMOS transistor is applied to a gate electrode of the pMOS transistor.

6. The power supply circuit according to claim 1, wherein the resistor element is connected between the source electrode of the first nMOS transistor and a node at a reference potential supplied to the semiconductor circuit.

7. The power supply circuit according to claim 1, wherein the resistor element is connected between the source electrode of the first nMOS transistor and a node at the power supply voltage supplied to the semiconductor circuit.

8. The power supply circuit according to claim 1, wherein the input circuit further comprises:
a second nMOS transistor with a gate electrode connected to the source electrode of the first nMOS transistor; and
an inverter circuit connected to a source electrode of the second nMOS transistor.

9. The power supply circuit according to claim 8, wherein the input circuit further comprises:
a second resistor element connected between a node at the power supply voltage and the source electrode of the second nMOS transistor;
a third resistor element connected to a drain electrode of the second nMOS transistor and a fourth resistor element connected to a ground potential; and
a third nMOS transistor with a gate electrode connected to the output terminal of the inverter and connected in parallel with the fourth resistor element.

10. The power supply circuit according to claim 8, wherein the input circuit further comprises:
a second resistor element connected to the source electrode of the second nMOS resistor; and
a third resistor element connected to a drain electrode of the second nMOS transistor, wherein the second resistor element, the second nMOS transistor, and the third resistor element are connected in series between the power supply voltage and a ground potential.

11. A power supply circuit, comprising:
an input circuit with an input terminal configured to receive an enable output voltage from the outside, the input terminal connected to a drain electrode of a first nMOS transistor;
a logic circuit configured to generate a first control signal in accordance with a source voltage of the first nMOS transistor;
a control circuit configured to generate, in response to the first control signal, a second control signal in accordance with a difference between a predetermined reference voltage and a feedback voltage corresponding to an output voltage;
a switching voltage generating unit configured to output, in response to the level of the first control signal, an input voltage or a ground voltage in accordance with the second control signal; and
an output voltage generating unit configured to produce an output voltage based on an output of the switching voltage generating unit.

12. The power supply circuit according to claim 11, wherein the control circuit comprises:
a second nMOS transistor comprising a drain electrode receiving the feedback voltage, a gate electrode receiving the power supply voltage, and a source electrode; and
an error amplifier configured to generate an error voltage corresponding to a difference between the predetermined reference voltage and a source voltage of the second nMOS transistor.

13. The power supply circuit according to claim 12, wherein the control circuit is a semiconductor integrated circuit; and the feedback voltage is supplied from outside of the semiconductor integrated circuit via an input terminal of the semiconductor integrated circuit.

14. The power supply circuit according to claim 11, further comprising:
a capacitor, wherein the control circuit includes:
a third nMOS transistor comprising a gate electrode receiving the power supply voltage, a source electrode connected to one end of the capacitor, and a drain electrode,
a current source connected to the drain electrode of the third nMOS transistor, and
an error amplifier configured to generate an error voltage representing the difference between the feedback voltage and a lower one of the predetermined reference voltage and a drain voltage of the third nMOS transistor.

15. The power supply circuit according to claim 14, wherein
the control circuit is a semiconductor integrated circuit;
the capacitor is disposed outside the semiconductor integrated circuit; and
one end of the capacitor and the source electrode of the third nMOS transistor are connected to an input terminal of the semiconductor integrated circuit.

16. A start control unit, comprising:
an inverter circuit connected between a input circuit and a logic circuit, the logic circuit configured to output a shut down signal to a control circuit, the shut down signal indicating an operation state of a device connected to the logic circuit;
an input circuit configured to receive an enable signal from an enable signal input terminal and to output an enable voltage at a high level or a low level according to the enable signal, the high level being less than a breakdown voltage of the inverter circuit; and
a protection circuit configured to output a protection signal at a high level or a low level based on a measured condition, wherein the input circuit includes:
a first nMOS transistor with a drain electrode connected to an enable voltage input terminal for receiving the enable voltage, a gate electrode for receiving a bias voltage, the bias voltage being higher than a power supply voltage supplied to the semiconductor circuit, and a source electrode connected to the semiconductor circuit, the first nMOS transistor having a breakdown voltage higher than the power supply voltage; and
a resistor element connected to the source electrode of the first nMOS transistor, wherein
the first nMOS transistor operates in a non-saturation range when the enable voltage is lower than or equal to a predetermined value and in a saturation range when the enable voltage is higher than the predetermined value.

17. The start control unit of claim 16, wherein the measured condition is a temperature.

18. The start control unit of claim 16, wherein the enable signal is a power supply voltage that is greater than a breakdown voltage of the inverter.

19. The start control unit of claim 16, wherein the logic circuit is an OR gate.

20. The start control unit of claim 16, wherein the shut down signal is supplied to one or more components of DC-DC converter.
